(19) United States
(12) Patent Application Publication
(10) Pub. No.: US 2005/0248775 A1
(43) Pub. Date: Nov. 10, 2005

(54) Apparatus for monitoring deposition processes

(75) Inventors: Dario Re, Torino (IT); Paolo Valenti, Torino (IT); Giuliana Morello, Torino (IT)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/025,104

(22) Filed: Dec. 29, 2004

(30) Foreign Application Priority Data
May 6, 2004 (GB) 0410099.6

(51) Int. Cl. G01B 11/28

(52) U.S. Cl. 356/630

(57) ABSTRACT

An apparatus for monitoring deposition processes which includes: a holder member for holding a device exposed to the coating process, the device adapted to be activated during the position process to generate a radiation affected by the deposition process, a detector for detecting the radiation to produce a monitoring signal of the deposition process, and an optical propagation path associated with the holder member to propagate the radiation towards the detector. The detector is unexposed to the deposition process, which preferably occurs by causing the optical propagation path to the photodetector to include an integration sphere provided in the holder member.

The present invention relates to techniques for monitoring deposition processes.

Deposition processes are common in various areas of technology and may be used e.g. in producing coatings adapted to vary the reflection characteristics of surfaces in opto-electronic devices.

Exemplary of such coatings are anti-reflective coatings (ARC) for which very low residual reflectivity (RR) values in the range of 10⁻⁴ or lower are desirable to ensure device functionality within the desirable specifications.

The RR value is strictly related to the thickness and refractive index of the layer(s) included in the ARC structure. In order to achieve the desired results, the thickness must be controlled within few nanometres and the refractive index within few percent units in order to achieve RR values of, e.g. 5.10⁻⁴ or lower.

What has been stated in the foregoing in connection with anti-reflective coatings essentially applies to reflective coatings obtained via deposition techniques in the case of e.g. laser devices.

Typical prior art arrangements for thickness and refractive index control in deposition processes typically imply the use of device such as quartz scales.

Such arrangements may essentially enable a sort of run-to-run reproducibility of the results of deposition processes. However, they are intrinsically not adapted to permit real-time control of deposition processes. Specifically, such prior art arrangements do not permit e.g. immediately stopping a deposition process once a thickness of the coating is reached that corresponds to a desired optimum value.

Additionally, in situ monitoring techniques based on ellipsometry are known and commercially available. Essentially, these techniques operate on spare samples located in the vicinity of the real device being coated and not on the real device itself. As a consequence, the resulting coating may turn out to be optimised on a structure having a different refractive index with respect with a real device being coated while the sample is located at a different position from the real device.

The need is therefore felt for improved solutions that overcome the intrinsic drawbacks of the prior art arrangements described in the foregoing.

The object of the present invention is to fulfil such a need.

According to the present invention, that object is achieved by means of apparatus having the features set forth in the claims that follows.

A preferred embodiment of the invention is adapted to directly monitor a real active device such as semiconductor laser being subjected to a coating process in terms of optical power and bias through the heterojunction.

A particularly preferred embodiment of the invention is adapted to hold both a device to be monitored as well as one or more device bars being coated concurrently. These possibly together with spare samples (such as parts of Si or InP substrates) to be used for further investigation.

Preferably, the position of the bar holder(s) can be adjusted in order to ensure that essentially the same value of deposition thickness is achieved for the device monitored and the bar or bars being coated.

A preferred embodiment of the arrangement described herein includes a photodetector to monitor the radiation emitted by a test device being coated. Deposition of coating material onto the photodetector is prevented by means of an optical system including e.g. an integration sphere.

A particularly preferred embodiment of the invention includes the provision of a cooling system and an improved integration sphere design that allows acquisition of the optical spectrum of the device coated as a function of the emitted wavelength.

The invention will now be described, by way of example only, with reference to the annexed figures of drawing, wherein:

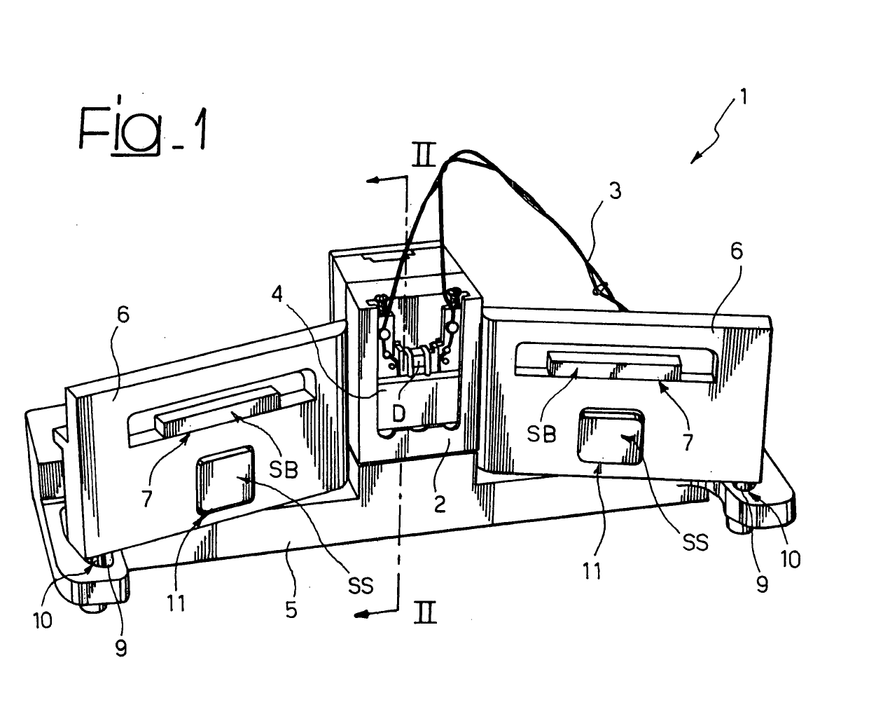

FIG. 1 is a general perspective view of apparatus according to the invention,

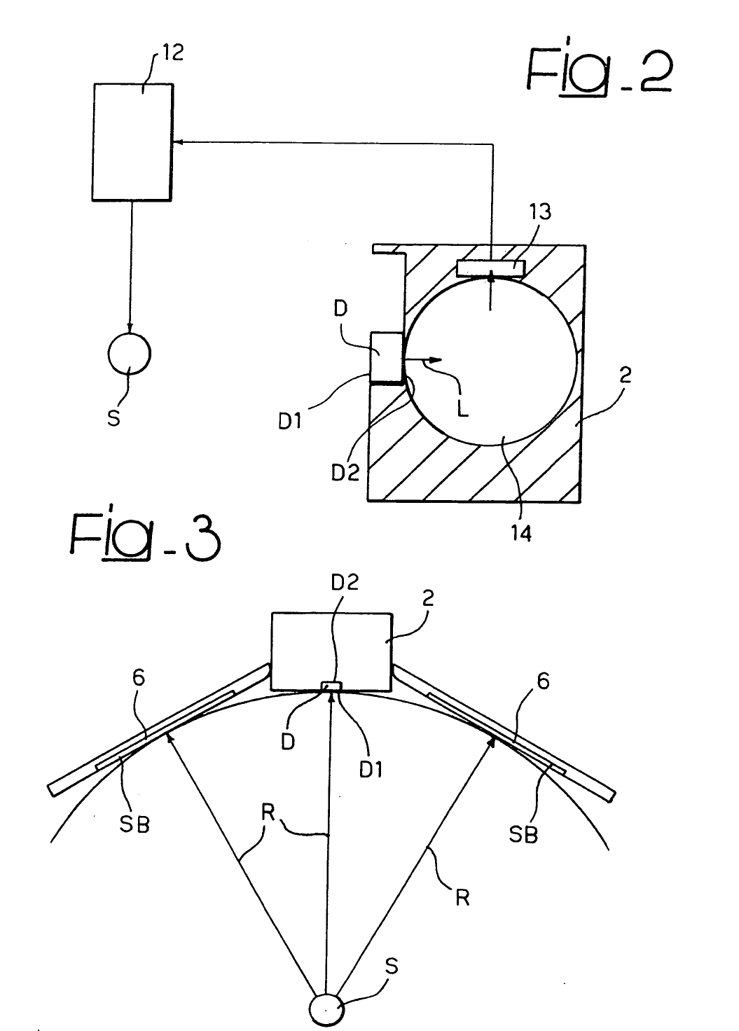

FIG. 2 is a cross-section view along the plane identified as II-II in FIG. 1, and

FIG. 3 is a schematic representation of the apparatus of FIG. 1 highlighting a preferred feature thereof.

In the annexed drawing, FIG. 1 designates as whole apparatus for use in coating opto-electronic devices such as e.g. semiconductor laser chips.

As is well known to those of skill in the art, such devices may require coatings of the anti-reflective and/or the reflective type in order to permit proper operation of the device itself.

Just by way of exemplary reference (not intended to limit in any way the scope of the invention) the opto-electronic device in question may be a semiconductor laser operating based on the Fabry-Perot principle. This requires a lasing cavity included between two end surfaces having well-defined reflective/anti-reflective characteristics.

For instance, at the front facet of the laser cavity the radiation generated should be partly reflected back into the cavity to sustain lasing operation and partly caused to exit the cavity as “useful” laser radiation.

Reflective/anti-reflective coatings can be deposited by resorting to various technologies (such as e.g. cathode spattering) and may be either single-layer or multi-layer.

Such coating technologies are well known in the art and do not require to be described in detail herein.

Apparatus 1 is generally intended to be located within a deposition chamber as provided in current deposition apparatus (such as e.g. cathode sputtering coating apparatus as manufactured by Balzers AG of Liechtenstein).

In operation, apparatus 1 is intended to located within a coating chamber (not shown) where the material being coated diffuses from a source S following an essentially spherical/cylindrical geometry. The significance of referring to this geometry will be better understood in the following.

Apparatus 1 as described herein can be essentially regarded as a sort of a jig adapted to support at least one “sacrificial” device D. Such a sacrificial device will be activated during the deposition process while monitoring for control purposes of the deposition process an optical radiation produced by the device D.

Obviously, “optical” is used herein with the meaning currently allotted to that term in connection with opto-electronic devices and is thus intended to cover, in addition to visible light radiation, also radiation e.g. in the IR and UV fields.

By way of direct reference, and again without any limiting intent of the scope of the invention, the device D will be hereinafter assumed to be a semiconductor laser mounted on a holder portion 2 of apparatus 1 in such a way to have a first facet D1 exposed to the source S of the coating material as well as a further facet D2 arranged at an opposite location to the face D1.

Reference 3 in FIG. 1 designates electrical connections permitting the device D to be activated during the coating process in such a way that a light radiation L emanates from the facet D2 of the device D2.

The holder portion 2 of apparatus 1 may be of any shape adapted to retain the device D with the spatial orientation described in the foregoing. In the exemplary embodiment shown in FIG. 1, the holder element 2 is generally provided with a front face having a channel-like formation adapted for receiving a support element 4 slidably inserted therein.

The device D is thus adapted to be mounted onto the support element 4 and fixed thereon with the provision of electrical contacts 3. The support element 4 is subsequently inserted in the channel-like formation of the front face of the holder element 2 to achieve the operational position shown in the figures of the drawing.

Those of skill in the art will promptly appreciate that such a mounting arrangement is in no way a mandatory requirement for the invention in that alternative, equivalent arrangements can be easily devised.

Operation of the arrangement described herein is based on the assumption that at least one characteristic of the radiation L (e.g. the intensity, the wavelengths or the spectral widths thereof—such a list being of exemplary nature only) may vary as a function of the characteristics—essentially the thickness and/or the refractive index—of the coating coated on the front face D1.

Monitoring such characteristics will therefore permit corresponding control of the deposition process. This will preferably occur in real-time conditions so that the coating process can be stopped as soon the optimal values for the coating deposited are reached, this condition being identified by monitoring the radiation L.

In the presently preferred embodiment as shown in FIG. 1, the apparatus 1 includes a base member 5 adapted to support, in addition to the holder element 2, at least one (and preferably two, as is the case of the exemplary embodiment shown) lateral “wing” portion 6. Such or each wing portion is in the form of generally planar plate having a proximal end arranged side-by-side with the holder member 2.

As better appreciated in the schematic plan view of FIG. 3, the wing portions 6 jointly define with the holder portion 2 a sort of polygonal, dihedral-like arrangement. This arrangement is adapted to ensure that, when the apparatus 1 is located within q deposition chamber, the front face of the holder member 2 (more to the point, the sacrificial device D mounted thereon) and the front faces of the “wing” portions 6 are at least approximately located at the same radial distances R from the source S (so-called “target”) of the material being deposited.

Reference numerals 7 designate in FIG. 1 two windows, slits, grooves or the like provided in the wing portion(s) 6 in order to receive one or more semiconductor bars SB having a front face exposed to the source S and thus intended to be coated during the deposition process.

According to well-known technology, after coating the front face, each bar SB will be sliced into individual semiconductor chips each intended to constitute the basic structure for a distinct opto-electronic device such as e.g. a semiconductor laser.

The arrangement described herein is thus intended to ensure that the same deposition conditions and results—as monitored on the sacrificial device D—are reproduced in a notionally identical manner in the semiconductor bars SB and the devices eventually produced from these bars.

The geometry of the deposition process (essentially the distance between the source S and the holder element 2) may vary depending on the processes and the characteristics of the coating apparatus used. The wing portion(s) 6 of the apparatus 1 are thus preferably mounted onto the base member 5 with the possibility of selectively adjusting the orientation of the or each wing portion 6. This makes it possible to easily adapt the dihedral-like arrangement schematically shown in FIG. 3 to different values for the radial distance R.

This result may be achieved, e.g. by providing the “distal” portion of the or each wing element 6 with a downwardly protruding pin 9 adapted to slide into and along a corresponding slit 10 provided at each outer end of the base member 5. Again, alternative arrangements adapted to provide equivalent results could be easily devised by those of skill in the art.

Reference numerals 11 indicate two further windows provided in the wing portions 6 in order to receive so-called spare samples SS (for instance parts of Si or InP substrates) that are again exposed to the coating process and may thus be used for further off-line control of the deposition process e.g. via a quartz scale.

Reference 12 in FIG. 3 designates a control device (either of the fully automated or the semi-automated type) adapted to control—in a manner known per se—the source S of the material being coated as a function of the control signal generated by a photodetector 13 that is impinged upon by the radiation L from the facet D2 of the sacrificial device 2.

As indicated, the characteristics of such radiation being monitored (for instance, intensity, wavelength, spectral width) are dictated by the coating being deposited and are thus indicative of e.g. the thickness or the thickness/refractive index product of the coating in question. Monitoring these characteristics of the radiation L thus amounts to monitoring the deposition process itself.

Even though intensity, wavelength, and spectral width represent the most common choices, those of skill in the art will promptly appreciate that the choice of the specific characteristic considered may per se be largely irrelevant for the invention.

The arrangement described herein specifically aims at ensuring that, whatever the characteristic monitored, the monitoring action is made thoroughly reliable by ensuring that the photodetector 13 is completely isolated from the deposition process and thus not affected thereby. This means that the material emanated from the source S should be prevented from depositing on to the light-sensitive surface of the photodetector 13 (which is typically comprised of a photodiode of any current type for opto-electronic applications).

In the exemplary embodiment shown in the drawing, that result is achieved by providing within the body of the holder element 2 a so-called integration sphere 14.

In the presently preferred arrangement described herein, the integration sphere 14 is provided within the holder body 2 in such a way that the radiation L from the sacrificial device D is injected into the sphere and toward the centre thereof from an “equatorial” position, while the photodetector 13 is arranged at a “polar” position of the sphere.

In that way the photodetector 10 is safely and reliably protected from the deposition process while the integration sphere represents an effective way for propagating and concentrating the radiation L from the device D on to the sensitive surface of the photodetector 13. A particularly preferred embodiment of the invention includes the provision of a cooling system and an improved integration sphere design that allows acquisition of the optical spectrum of the device coated as a function of the emitted wavelength.

Of course, without prejudice to the underlying principle of the invention, the details and the embodiments may vary, also significantly, with respect to what has been described and shown, by way of example only, without departing from the scope of the invention as defined in the claims that follow.

1. An apparatus for monitoring a deposition process, the apparatus comprising:
a holder member for holding a device exposed to said deposition process, said device adapted to be activated during the deposition process to generate a radiation affected by the deposition process,
a detector adapted to detect said radiation to produce a monitoring signal of said deposition process, and
an optical propagation path associated with said holder member to propagate said radiation toward said detector, wherein said detector is arranged at a location unexposed to said deposition process.

2. The apparatus of claim 1, wherein said optical propagation path comprises an integration sphere associated with said holder member.

3. The apparatus of claim 2, wherein said radiation is injected into said integration sphere at one of a first position and a second position and said detector is associated to said integration sphere at the other of said first position and second positions, wherein said first and second positions are an equatorial position and a polar position of said integration sphere.

4. The apparatus of claim 1, wherein said holder member has a front face for carrying said at least one device at a position exposed to the source of the material being deposited.

5. The apparatus of claim 4, further comprising a support element (4) for carrying said at least one device, said support element being removably associated with said holder member.

6. The apparatus of claim 5, wherein said support element is slidably associated with said holder member.

7. The apparatus of claim 1, further comprising an associated electrical feed for said device to be activated during the deposition process.

8. The apparatus of claim 1, further comprising at least one associated support element for supporting at least one additional piece to be coated during said deposition process.

9. The apparatus of claim 8, wherein said at least one piece includes a device (DB) to be coated by said deposition process and said associated support element includes a formation for locating said device (SB).

10. The apparatus of claim 8, wherein said at least one piece includes a test element and said associated support element includes a holder for holding said test element.

11. The apparatus of claim 8, wherein said holder member and said at least one associated support element are arranged at substantially identical radial distances from a location for the source of the material deposited in said deposition process.

12. The apparatus of claim 11, wherein two said associated support elements are in a general dihedral arrangement.

13. The apparatus of claim 8, wherein said holder member and said at least one associated support member are arranged for selectively varying the mutual orientation thereof.

14. The apparatus of claim 13, further comprising:
a base member supporting said holder member, and
said at least one associated support members having a proximal end near said holder member and a distal end slidably supported by said base member to permit selectively varying the mutual orientation of said holder member and said at least one associated support element.

15. An apparatus for monitoring a deposition process, the apparatus including:
a holder member for holding a device exposed to said deposition process, said device adapted to be activated during the deposition process to generate a radiation affected by the deposition process,
a detector adapted to detect said radiation to produce a monitoring signal of said deposition process, and
an optical propagation path associated with said holder member to propagate said radiation toward said detector, wherein said detector is arranged at a location unexposed to said deposition process, said optical propagation path including an integration sphere associated with said holder member.
